(19) United States
(12) Patent Application Publication
(10) Pub. No.: US 2012/0148118 A1
(43) Pub. Date: Jun. 14, 2012

(54) METHOD FOR CLASSIFYING IMAGES AND APPARATUS FOR THE SAME

(75) Inventors: Keun Dong LEE, Daejeon (KR); Weon Geun Oh, Daejeon (KR); Sung Kwan Je, Daejeon (KR); Hyuk Jeong, Daejeon (KR); Sang II Na, Seoul (KR); Robin Kalia, Daejeon (KR)

(73) Assignee: ELECTRONICS AND TELECOMMUNICATIONS RESEARCH INSTITUTE, Dajeon (KR)

(21) Appl. No.: 13/311,943

(22) Filed: Dec. 6, 2011

(30) Foreign Application Priority Data
Dec. 9, 2010 (KR) 10-2010-0125865

(51) Int. Cl. G06K 9/00

(52) U.S. Cl. 382/118

(57) ABSTRACT

An image classifying apparatus may include a database constructor which constructs database by detecting face region from received classification target image, extracting face feature descriptor from detected face region, extracting a costume feature descriptor using position information of detected face region, and storing face feature descriptor and costume feature descriptor in database, a first processor which generates representative image model by comparing face feature descriptor and costume feature descriptor of classification target image stored in database based on a received representative image to search for a similar image and registering similar image in a representative image model for each person, and second processor which compares additional information of representative image stored in representative image model for each person and additional information of classification target image stored in database and classifies image for each person based on similarity measured by adding up weights corresponding to similarities according to comparison results.

### CROSS-REFERENCE TO RELATED PATENT APPLICATION

This application claims the benefit of Korean Patent Application No. 10-2010-0125865, filed on Dec. 9, 2010, in the Korean Intellectual Property Office, the disclosure of which is incorporated herein in its entirety by reference.

### BACKGROUND OF THE INVENTION

1. Field of the Invention

The present invention relates to a method for classifying images and an apparatus for the same and, more particularly, to a method for classifying images and an apparatus for the same, which can classify a plurality of classification target images for each person based on a representative image.

2. Description of the Related Art

Recently, with the spread of digital cameras, each user can have many images. Thus, the user may want to select and view a desired image, for example, an image with a specific face and may want to classify a plurality of images according to predetermined criteria. In general, the user finds an image of a specific person or classifies a plurality of images according to predetermined criteria using a face recognition technique. The existing face recognition techniques find an image of a specific person or classify a plurality of images according to predetermined criteria based on face regions of similar size, uniform illumination and background, or database of images taken by the same camera.

However, the plurality of images that the user has may have different shooting information such as face regions, backgrounds, illumination, face directions, face brightness, etc. In particular, the user is likely to share the images with others and thus has many images taken by his or her camera, images taken by other people's camera, or images taken by a mobile camera.

When the models of cameras that take the plurality of images that the user has are different from each other, the images have very different characteristics such as colors, focuses and details. For example, when comparing an image taken by a DSLR camera with an image taken by a mobile camera among the plurality of images that the user has, the images containing the same subject have very different characteristics such as colors, focuses and details.

Moreover, when the sizes of face regions are different from each other among the plurality of images that the user has, the details of the faces are different with respect to the face region, and thus characteristics of face feature descriptors extracted from the face regions of the images will be different from each other. For example, the detail of the face in the face region of an image taken by a camera placed 10 m away from the subject is different from that of an image taken by the camera placed 100 m away from the subject among the plurality of images that the user has, and thus the characteristics of face feature descriptors extracted from the face regions of the images will be different from each other.

Further, the characteristics of face feature descriptors extracted from the face regions of the images of the same person are difference from each other depending on shooting information on the plurality of images that the user has, such as exposure time, shutter speed, aperture opening, flash status, etc.

Therefore, when the plurality of image taken by different cameras under different environments are classified based on the database composed of face regions of similar size, the uniform illumination and background, or the images taken by the same camera, it is very difficult to accurately classify the plurality of images. Moreover, while the user can classify the plurality of images taken by different cameras under different environments using various samples, it is troublesome for the user to designate the various samples, and it is impossible to accurately designate the samples since the user designates the samples manually.

### SUMMARY OF THE INVENTION

The present invention has been made in an effort to solve the above-described problems associated with prior art, and a first object of the present invention is to provide an image classification apparatus which can classify a plurality of classification target images for each person based on a representative image.

A second object of the present invention is to provide an image classification method which can classify a plurality of classification target images for each person based on a representative image.

According to an aspect of the present invention to achieve the first object of the present invention, there is provided an image classification apparatus comprising: a database constructor which constructs a database by detecting a face region from a received classification target image, extracting a face feature descriptor from the detected face region, extracting a costume feature descriptor using position information of the detected face region, and storing the face feature descriptor and the costume feature descriptor in the database; a first processor which generates a representative image model by comparing the face feature descriptor and the costume feature descriptor of the classification target image stored in the database based on a received representative image to search for a similar image and registering the similar image in a representative image model for each person; and a second processor which compares additional information of the representative image stored in the representative image model for each person and additional information of the classification target image stored in the database and classifies the image for each person based on the similarity measured by adding up weights corresponding to similarities according to the comparison results.

According to another aspect of the present invention to achieve the second object of the present invention, there is provided an image classification method comprising: constructing a database by detecting a face region from a received classification target image, extracting a face feature descriptor from the detected face region, extracting a costume feature descriptor using position information of the detected face region, and storing the face feature descriptor and the costume feature descriptor in the database; generating a representative image model by comparing the face feature descriptor and the costume feature descriptor of the classification target image stored in the database based on a received representative image to search for a similar image and registering the similar image in a representative image model for each person; and comparing additional information of the representative image stored in the representative image model for each person and additional information of the classification target image stored in the database and classifying the image for each person based on the similarity measured by adding up weights corresponding to similarities according to the comparison results.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing the internal structure of an image classification apparatus in accordance with an exemplary embodiment of the present invention; and

FIG. 2 is a schematic diagram showing a process in which a database constructor in an image classification apparatus in accordance with an exemplary embodiment of the present invention constructs a database by extracting a face feature descriptor and a costume feature descriptor;

FIG. 3 is a schematic diagram showing a process in which a second matching unit of a second processor in an image classification apparatus in accordance with an exemplary embodiment of the present invention measures the similarity between a representative image stored in a representative image model and a classification target image stored in a database constructed by the database constructor; and

FIG. 4 is a flowchart showing a method for classifying images for each person in accordance with another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

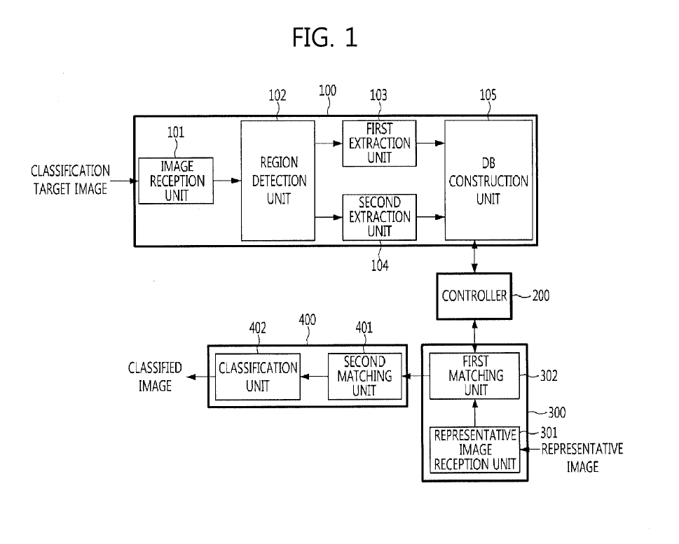

FIG. 1 is a schematic diagram showing the internal structure of an image classification apparatus in accordance with an exemplary embodiment of the present invention.

Referring to FIG. 1, the image classification apparatus may comprise a first processor 300, a second processor 400, a controller 200, and a database constructor 100. The data constructor 100 may comprise an image reception unit 101, a region detection unit 102, a first extraction unit 103, a second extraction unit 104, and a DB construction unit 105. The first processor 300 may comprise a representative image reception unit 301 and a first matching unit 302, and the second processor 400 may comprise a second matching unit 401 and a classification unit 402.

The image reception unit 101 receives a plurality of images from a user. According to an exemplary embodiment of the present invention, when the user designates a path in which a plurality of classification target images that the user wants to classify for each person are stored in a personal image management system, the image reception unit 101 receives the plurality of classification target images stored in the path designated by the user.

The region detection unit 102 detects a face region from classification target images received from the image reception unit 101. According to the exemplary embodiment of the present invention, the image detection unit 102 may detect a face region from images received from the image reception unit 101 using the Viola-Jones face detection method.

The first extraction unit 103 extracts a face feature descriptor from the face region detected by the region detection unit 102. First, when the image reception unit 101 receives a plurality of classification target images, a process in which a plurality of face regions of the plurality of classification target images are detected by the region detection unit 102 will now be described. The first extraction unit 103 extracts a plurality of face feature descriptors from the plurality of face regions of the plurality of classification target images detected by the region detection unit 102. According to the exemplary embodiment of the present invention, the first extraction unit 103 may extract the face feature descriptors from the face regions detected by the region detection unit 102 using LBP, PCA and Gabor methods.

The second extraction unit 104 receives the face regions detected by the region detection unit 102 and the face feature descriptors extracted by the first extraction unit 103, extracts shooting information using exchangeable image file format (hereinafter referred to as EXIF) information, and extracts costume feature descriptors from the images using the position information of the face regions detected by the region detection unit 102. According to the exemplary embodiment of the present invention, the second extraction unit 104 may extract the shooting information of the classification target images using the EXIF information stored in the classification target images. Here, the shooting information may comprise focal length, exposure time, shutter speed, aperture opening, flash status, and camera model of the classification target images.

According to the exemplary embodiment of the present invention, the second extraction unit 104 extracts a dominant color information and LBP as a costume feature descriptors of the classification target images using the position information of the face regions detected by the region detection unit 102.

The DB construction unit 105 constructs a database using the face feature descriptors received from the first extraction unit 103 and the costume feature descriptors received from the second extraction unit 104.

The representative image reception unit 301 receives representative images for each person to be classified.

The first matching unit 302 receives the representative images from the representative image reception unit 301 and receives the database constructed by the database constructor 100 under the control of the controller 200. The first matching unit 302 searches for a similar image using the face feature descriptors and the costume feature descriptors of the classification target images stored in the database based on the representative images received from the representative image reception unit 301 and registers the similar image in a representative image model, thus generating the representative image model for each person.

Here, since the first matching unit 302 searches for the similar image using the face feature descriptors and the costume feature descriptors of the classification target images stored in the database, it is possible to increase the probability of finding an image of the same person as the representative image. Moreover, the first matching unit 302 can automatically collect learning images for the representative image without the user intervention, thus generating the representative image model for each person. Furthermore, since the first matching unit 302 registers the images of the same person as the representative image in the representative image model, it is possible to ensure that representative image model includes images with different additional informations such as date, illumination, shutter speed, camera model, etc. with respect to each person.

The second matching unit 401 receives the representative image model for each person generated by the first matching unit 302 and receives the classification target image stored in the database constructed by the database constructor 100 under the control of the controller 200. Here, the classification target image stored in the database constructed by the database constructor 100 does not include the representative image and the image used for generating the representative image model. The second unit 401 compares and matches the additional information of the classification target image stored in the database constructed by the database constructor 100 under the control of the controller 200 and the additional information of the representative image stored in the representative image model.

First, if it is determined that the additional information of the classification target image stored in the database constructed by the database constructor 100 under the control of the controller 200 is similar to the additional information of the representative image stored in the representative image model, the second matching unit 401 gives a higher weight to the similarity measured using only the face feature descriptors between two images. On the contrary, if it is determined that the additional information of the classification target image stored in the database constructed by the database constructor 100 under the control of the controller 200 is not similar to the additional information of the representative image stored in the representative image model, the second matching unit 401 gives a lower weight to the similarity measured using only the face feature descriptors between two images.

After that, the second matching unit 401 measures the similarity for each person by adding up the similarities.

The classification unit 402 compares the similarity measured by the second matching unit 401 with a predetermined threshold value to determine whether or not the corresponding classification target image is similar to the representative image for each person. First, as a result that the classification unit 402 receives the similarity measured by the second matching unit 401 and compares the received similarity with the predetermined threshold value, if it is determined that the similarity measured by the second matching unit 401 is greater than the predetermined threshold value, the classification unit 402 determines that the corresponding classification target image is similar to the representative image for each person, thus classifying the corresponding classification target image as an image that is similar to the representative image.

Second, as a result that the classification unit 402 receives the similarity measured by the second matching unit 401 and compares the received similarity with the predetermined threshold value, if it is determined that the similarity measured by the second matching unit 401 is smaller than the predetermined threshold value, the classification unit 402 determines that the corresponding classification target image is not similar to the representative image for each person, thus classifying the corresponding classification target image as an image that is not similar to the representative image.

The controller 200 transmits the classification target image stored in the database of constructed by the database constructor 100 to the first matching unit 302. Moreover, as the first matching unit 302 searches for a similar image using the face feature descriptor and the costume feature descriptor of the classification target image stored in the database of constructed by the database constructor 100 based on the representative image and registers the similar image in the representative image model, the controller 200 deletes the representative image and the image used for generating the representative image model from the classification target image stored in the database of constructed by the database constructor 100.

The controller 200 transmits the classification target image stored in the database of constructed by the database constructor 100 to the second matching unit 401. Here, the classification target image stored in the database constructed by the database constructor 100 does not include the representative image and the image used for generating the representative image model.

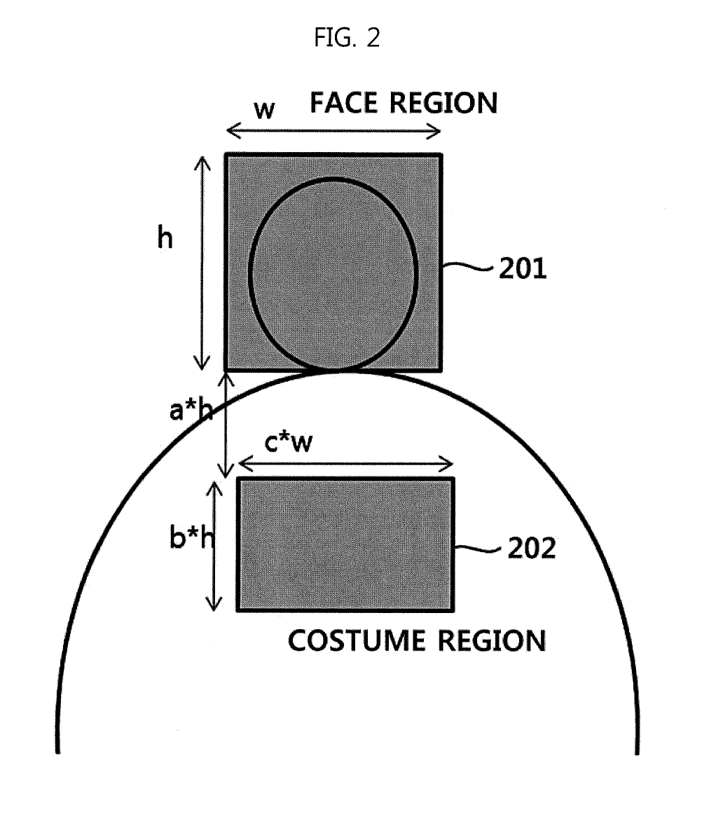

Next, the process in which the extraction units 103 and 104 of the image classification apparatus in accordance with the exemplary embodiment of the present invention extract the face feature descriptor and the costume feature descriptor will be described in more detail with reference to FIG. 2.

FIG. 2 is a schematic diagram showing a process in which the database constructor of the image classification apparatus in accordance with the exemplary embodiment of the present invention extracts the face feature descriptor and the costume feature descriptor and constructs a database.

Referring to FIG. 2, the image reception unit 101 receives a plurality of classification target images from a user, and the region detection unit 102 detects a face region from images received from the image reception unit 101. The first extraction unit 103 extracts a face feature descriptor from the face region detected by the region detection unit 102. The second extraction unit 104 receives the face region detected by the region detection unit 102 and the face feature descriptor extracted by the first extraction unit 103, extracts shooting information using EXIF information, and extracts a costume feature descriptor from the image using the position information of the face region detected by the region detection unit 102.

According to the exemplary embodiment of the present invention, when the image reception unit 101 receives a plurality of classification target images, a process in which a face region 201 of the classification target image is detected by the region detection unit 102 and a face feature descriptor is extracted by the region detection unit 102 will now be described. The second extraction unit 104 extracts shooting information of the classification target image using the EXIF information and extracts a costume feature descriptor of a costume region 202 having a width of c*w and a height of b*h and present at a position a*h away from the lower left of the face region detected from the classification target image using color and texture descriptors by referring to location of the face region 201 having a size of width (w)*height (h) detected by the region detection unit 102.

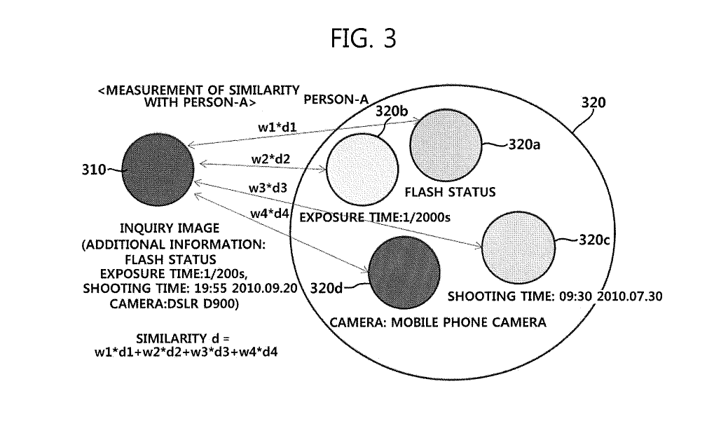

Next, the process in which the second matching unit 401 of the second processor 400 in the image classification apparatus measures the similarity between the representative image stored in the representative image model for each person and the classification target image stored in the database constructed by the database constructor 100 will be described in more detail with reference to FIG. 3.

FIG. 3 is a schematic diagram showing a process in which the second matching unit 401 of the second processor 400 in the image classification apparatus in accordance with an exemplary embodiment of the present invention measures the similarity between the representative image stored in the representative image model for each person and the classification target image stored in the database constructed by the database constructor 100.

Referring to FIG. 3, the second matching unit 401 receives representative images 320 for each person generated by the first matching unit 302 and a classification target image 310 stored in the database constructed by the database constructor 100 under the control of the controller 200. Here, the classification target image 310 stored in the database constructed by the database constructor 100 does not include the representative image and the image used for generating the representative image model. The second matching unit 401 compares and matches the classification target image stored in the database constructed by the database constructor 100 under the control of the controller 200 and the representative image 320 stored in the representative image model for each person.

First, the second matching unit 401 compares additional information of the classification target image 310 stored in the database constructed by the database constructor 100 under the control of the controller 200 and additional information of the representative image 320 stored in the representative image model. If it is determined that they are similar to each other, the second matching unit 401 gives a higher weight to the similarity measured using only the face feature descriptors between two images. According to the exemplary embodiment of the present invention, the second matching unit 401 compares the additional information of the classification target image 310 stored in the database constructed by the database constructor 100 under the control of the controller 200 and the additional information of the representative images 320a, 320b, 320c and 320d of person-A stored in the representative image model. That is, the second matching unit 401 compares the flash status of the representative images 320a, 320b, 320c and 320d of person-A stored in the representative image model and that of the classification target image 310 and determines that both the classification target image 310 and the first representative image 320a among the representative images 320a, 320b, 320c and 320d of person-A stored in the representative image model are taken using a flash. Therefore, the second matching unit 401 gives a higher weight w1 to the similarity d1 measured using only the face feature descriptors between the classification target image 310 and the first representative image 320a of person-A.

On the contrary, if it is determined that the additional information of the classification target image 310 stored in the database constructed by the database constructor 100 under the control of the controller 200 is not similar to the additional information of the representative image 320 stored in the representative image model, the second matching unit 401 gives a lower weight to the similarity measured using only the face feature descriptors between two images. According to the exemplary embodiment of the present invention, the second matching unit 401 compares the exposure time of the representative images 320a, 320b, 320c and 320d of person-A stored in the representative image model and that of the classification target image 310. As a result, it is determined that the exposure time of the classification target image 310 is 1/200s and that of the second representative image 320b is 1/2,000s, which are different from each other, and thus the second matching unit 401 gives a lower weight w2 to the similarity d2 measured using only the face feature descriptors between the classification target image 310 and the second representative image 320b of person-A.

According to the exemplary embodiment of the present invention, the second matching unit 401 compares the shooting time of the representative images 320a, 320b, 320c and 320d of person-A stored in the representative image model and that of the classification target image 310. As a result, it is determined that the shooting time of the classification target image 310 is 19:55 2010 Sep. 20 and that of the third representative image 320c is 09:30 2010 Jul. 30, which are different from each other, and thus the second matching unit 401 gives a lower weight w3 to the similarity d3 measured using only the face feature descriptors between the classification target image 310 and the third representative image 320c of person-A.

According to the exemplary embodiment of the present invention, the second matching unit 401 compares the camera model of the representative images 320a, 320b, 320c and 320d of person-A stored in the representative image model and that of the classification target image 310. As a result, it is determined that the camera model of the classification target image 310 is DSLR D900 and that of the fourth representative image 320d is a mobile phone camera, which are different from each other, and thus the second matching unit 401 gives a lower weight w4 to the similarity d4 measured using only the face feature descriptors between the classification target image 310 and the fourth representative image 320d of person-A.

Then, the second matching unit 401 measures the similarity d with respect to person-A by adding up the similarities d1 to d4 with the weights of w1 to w4.

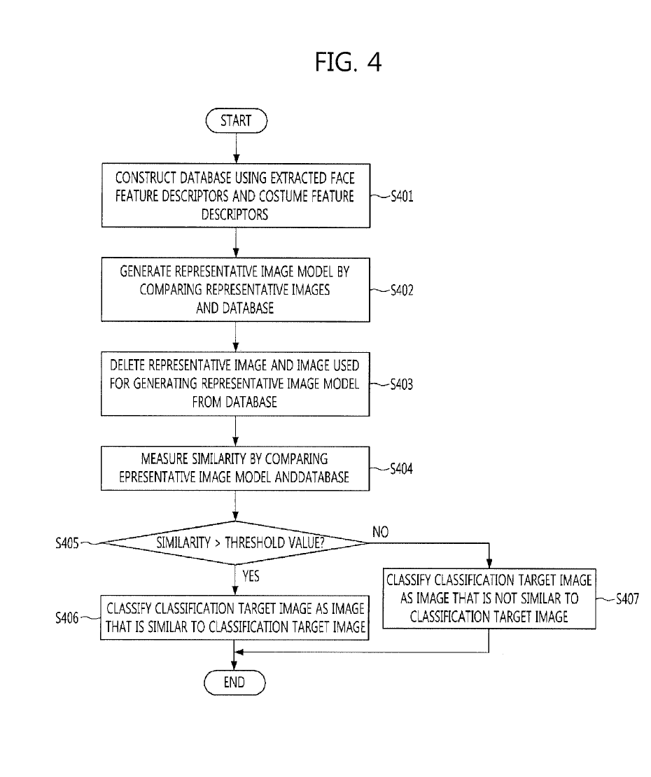

Next, a method for classifying images for each person in accordance with another exemplary embodiment of the present invention will be described with reference to FIG. 4.

FIG. 4 is a flowchart showing a method for classifying images for each person in accordance with another exemplary embodiment of the present invention.

Referring to FIG. 4, an image classification apparatus receives a plurality of classification target images, detects a face region, extracts a face feature descriptor from the detected face region, and extracts a costume feature descriptor using the position of the face region, thereby constructing a database.

In more detail, when a user designates a path, in which a plurality of classification target images that the user wants to classify for each person are stored in a personal image management system, the image classification apparatus receives the plurality of classification target images stored in the designated path from the user. Then, the image classification apparatus detects a face region from classification target images. According to the exemplary embodiment of the present invention, the image classification apparatus may detect a face region from images using the Viola-Jones face detection method.

After that, the image classification apparatus extracts a face feature descriptor from the detected face region. When the image classification apparatus receives a plurality of classification target images, a process in which a plurality of face regions of the plurality of classification target images are detected will now be described. The image classification apparatus extracts a plurality of face feature descriptors from the plurality of face regions detected from the received plurality of classification target images using LBP, PCA and Gabor methods.

The image classification apparatus extracting the face feature descriptors extracts shooting information using exchangeable image file format (EXIF) information and extracts costume feature descriptors from the images using the position information of the detected face regions. According to the exemplary embodiment of the present invention, the image classification apparatus may extract the shooting information of the classification target images using the EXIF information stored in the classification target images. Here, the shooting information may comprise focal length, exposure time, shutter speed, aperture opening, flash status, and camera model of the classification target images.

According to the exemplary embodiment of the present invention, the image classification apparatus extracts a dominant color information and LBP as a costume feature descriptors of the classification target images using the position information of the detected face regions.

The image classification apparatus constructs a database using the extracted face feature descriptors and costume feature descriptors (S401).

The image classification apparatus receives representative images for each person to be classified, searches for a similar image using the face feature descriptors and the costume feature descriptors of the classification target images stored in the database based on the received representative images, and registers the similar image in a representative image model, thus generating a representative image model for each person (S402). The image classification apparatus deletes the representative image and the image used for generating the representative image model from the classification target image stored in the database (S403).

Since the image classification apparatus searches for the similar image using the face feature descriptors and the costume feature descriptors of the classification target images stored in the database, it is possible to increase the probability of finding an image of the same person as the representative image. Moreover, the image classification apparatus can automatically collect learning images for the representative image without the user intervention, thus generating the representative image model for each person. Furthermore, since the image classification apparatus registers the image of the same person as the representative image in the representative image model, it is possible to ensure that representative image model includes images with different additional informations such as date, illumination, shutter speed, camera model, etc. with respect to each person.

The image classification apparatus measures the similarity by comparing the classification target image stored in the database and the representative image model for each person (S404). The image classification apparatus compares additional information of the classification target image stored in the database and additional information of the representative image stored in the representative image model and, if it is determined that they are similar to each other, gives a higher weight to the similarity measured using only the face feature descriptors between two images. On the contrary, if it is determined that the additional information of the classification target image stored in the database is not similar to the additional information of the representative image stored in the representative image model, the image classification apparatus gives a lower weight to the similarity measured using only the face feature descriptors between two images. Then, the image classification apparatus measures the similarity for each person by adding up the similarities.

The image classification apparatus receives the measured similarity and compares the similarity with a predetermined threshold value (S405) and, if the measured similarity is greater than the predetermined threshold value, determines that the corresponding classification target image is similar to the representative image of a specific person, thereby classifying the corresponding classification target image as an image that is similar to the representative image (S406). Otherwise, if the measured similarity is smaller than the predetermined threshold value, the image classification apparatus determines that the corresponding classification target image is not similar to the representative image, thereby classifying the corresponding classification target image as an image that is not similar to the representative image (S407).

As described above, when the method for classifying a plurality of classification target images for each person based on a representative image and the apparatus for the same according to the present invention are used, it is possible to obtain samples representing a person using the face feature descriptors and the costume feature descriptors extracted from the images in a personal image management system, thereby increasing the convenience of users and the accuracy of the recognition using various models.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An image classification apparatus comprising:
a extractor which detects a face region from a classification target image, extracts a face feature descriptor from the detected face region, detects a costume region using location of the detected face region in the a classification target image and extracts a costume feature descriptor from the detected costume region;
a database constructor which constructs a database by detecting a face region from a classification target image, extracting a face feature descriptor from the detected face region, extracting a costume feature descriptor using position information of the detected face region, and storing the face feature descriptor and the costume feature descriptor in the database;
a first processor which generates a representative image model by comparing the face feature descriptor and the costume feature descriptor of the classification target image stored in the database based on a received representative image to search for a similar image and registering the similar image in a representative image model for each person; and
a second processor which compares additional information of the representative image stored in the representative image model for each person and additional information of the classification target image stored in the database and classifies the image for each person based on the similarity measured by adding up weights corresponding to similarities according to the comparison results.

2. The image classification apparatus of claim 1, wherein the second processor increases the weight of the similarity measured using the face feature descriptors between two images if it is determined from the comparison that the additional information of the representative image stored in the representative image model for each person is similar to the additional information of the classification target image stored in the database.

3. The image classification apparatus of claim 1, wherein the second processor reduces the weight of the similarity measured using the face feature descriptors between two images if it is determined from the comparison that the additional information of the representative image stored in the representative image model for each person is not similar to the additional information of the classification target image stored in the database.

4. The image classification apparatus of claim 1, wherein the second processor classifies the corresponding image as an image that is not similar to the representative image if the measured similarity is smaller than a predetermined threshold value.

6. The image classification apparatus of claim 1, wherein the second processor classifies the corresponding image as an image that is similar to the representative image if the measured similarity is greater than a predetermined threshold value.

6. The image classification apparatus of claim 1, wherein the database constructor extracts shooting information of the classification target image using exchangeable image file format information stored in the classification target image.

7. The image classification apparatus of claim 1, wherein the database constructor extracts a costume feature descriptor from a costume region having a predetermined size and present at a position a predetermined distance away from the lower left of the face region detected from the classification target image.

8. The image classification apparatus of claim 1, further comprising a controller which transmits the database to the first processor.

9. The image classification apparatus of claim 8, wherein the controller deletes the received representative image for each person and the image used for generating the representative image model from the database.

10. The image classification apparatus of claim 8, wherein the controller transmits the database, from which the received representative image for each person and the image used for generating the representative image model, are deleted, to the second processor.

11. An image classification method comprising:
constructing a database by detecting a face region from a received classification target image, extracting a face feature descriptor from the detected face region, extracting a costume feature descriptor using position information of the detected face region, and storing the face feature descriptor and the costume feature descriptor in the database;
generating a representative image model by comparing the face feature descriptor and the costume feature descriptor of the classification target image stored in the database based on a received representative image to search for a similar image and registering the similar image in a representative image model for each person; and
comparing additional information of the representative image stored in the representative image model for each person and additional information of the classification target image stored in the database and classifying the image for each person based on the similarity measured by adding up weights corresponding to similarities according to the comparison results.

12. The image classification method of claim 11, wherein in the classifying of the image, the weight of the similarity measured using the face feature descriptors between two images is increased if it is determined from the comparison that the additional information of the representative image stored in the representative image model for each person is similar to the additional information of the classification target image stored in the database.

13. The image classification method of claim 11, wherein in the classifying of the image, the weight of the similarity measured using the face feature descriptors between two images is reduced if it is determined from the comparison that the additional information of the representative image stored in the representative image model for each person is not similar to the additional information of the classification target image stored in the database.

14. The image classification method of claim 11, wherein in the classifying of the image, the corresponding image is classified as an image that is not similar to the representative image if the measured similarity is smaller than a predetermined threshold value.

15. The image classification method of claim 11, wherein in the classifying of the image, the corresponding image is classified as an image that is similar to the representative image if the measured similarity is greater than a predetermined threshold value.

16. The image classification method of claim 11, wherein in the storing of the face feature descriptor and the costume feature descriptor in a database, shooting information of the classification target image is extracted using exchangeable image file format information stored in the classification target image.

17. The image classification method of claim 11, wherein in the storing of the face feature descriptor and the costume feature descriptor in a database, a costume feature descriptor is extracted from a costume region having a predetermined size and present at a position a predetermined distance away from the lower left of the face region detected from the classification target image.

18. The image classification method of claim 11, further comprising controlling the database to be used to generate the representative image model.

19. The image classification method of claim 18, wherein in the controlling of the database, the received representative image for each person and the image used for generating the representative image model are deleted from the database.

20. The image classification method of claim 18, wherein in the controlling of the database, the database, from which the received representative image for each person and the image used for generating the representative image model are deleted, are used to classify the image.
